(19) United States
(12) Patent Application Publication
(10) Pub. No.: US 2023/0200381 A1
(43) Pub. Date: Jun. 29, 2023

(54) PARTICULATE ANTIMICROBIAL HYBRID SYSTEM

(71) Applicant: AGXX Intellectual Property Holding GmbH, Berlin (DE)

(72) Inventors: Uwe Landau, Berlin (DE); Carsten Meyer, Berlin (DE); Olaf Wagner, Berlin (DE)

(73) Assignee: AGXX Intellectual Property Holding GmbH, Berlin (DE)

(21) Appl. No.: 17/926,580

(22) PCT Filed: May 26, 2021
(86) PCT No.: PCT/EP2021/064115

§ 371 Date: Nov. 19, 2022

(30) Foreign Application Priority Data
May 26, 2020 (EP) 20176476.8
Aug. 5, 2020 (EP) 20189686.7
Sep. 11, 2020 (EP) 20195711.5

(51) Int. Cl. A01N 25/26; A01N 59/16; C09D 7/62; C09D 5/14; A01P 1/00

(52) U.S. Cl. CPC A01N 25/26; A01N 59/16; A01P 1/00; C09D 5/14; C09D 7/62

(57) ABSTRACT

The invention relates to a hybrid material, in particular provided as an additive relating to materials, substances and/or coating materials for producing an antimicrobial, antiviral and/or fungicidal effect, and which comprises particles, each of which comprising at least one carrier material being at least partially coated with at least two different metals, wherein at least one first metal and one second metal are, at least with their respective surfaces, in electrically conductive contact to each other. According to the invention the first metal comprises at least one semiconductive compound of at least one transition metal element, which exhibits multiple oxidation states and allows a change of the oxidation states by means of catalytically active centers, and the second metal comprises at least one electrically conductive silver semiconductor, wherein both metals establish half cells which are short-circuited in the presence of water and oxygen and thus develop an antimicrobial, antiviral and/or fungicidal effect, wherein the carrier material comprises at least one material being adapted to the substance and/or the coating material and their use. The hybrid material according to the invention can be advantageously used as antimicrobial additive for various materials, substances and/or coating materials, preferably lacquers, paints, plastering, polymers and/or cellulose.

### BACKGROUND OF THE INVENTION

The invention relates to a hybrid material, in particular provided as an additive relating to materials, substances and/or coating materials for producing an antimicrobial, antiviral and/or fungicidal effect, and which comprises particles, each of which comprising at least one carrier material being at least partially coated with at least two different metals, wherein at least one first metal and one second metal are, at least with their respective surfaces, in electrically conductive contact to each other. The invention further relates to a method for producing a particulate hybrid material having antimicrobial activity, and to the use of such a particulate hybrid material.

As a rule, additives must possess a number of properties that often cannot be achieved on the basis of a base material alone. Desired property profiles can be adjusted by means of surface technology. Often, properties are required that cannot be achieved by one material alone, but only by several surface materials consisting of different components. Such multi-component systems are also referred to as hybrid material systems.

Antimicrobial devices and products have been used in sensitive areas such as medical and hygiene technology and food processing for some time. The current SARS-CoV-2 pandemic, but also many previous epidemics, have brought the topic of hygiene and protection against pathogenic microorganisms very far into the consciousness of the population and extended the need for antimicrobial protection to all areas of life. Due to the huge negative impact on the global economy, the current situation highlights the importance of antimicrobial protection and that the need for highly effective antimicrobial protection materials will increase significantly. Especially for items that are frequently touched or serve as antimicrobial protective equipment, such as mouth masks, there is an increasing need for more powerful and durable antimicrobial systems that can be well processed and integrated into products.

### PRIOR ART

Previous solutions in the field of antimicrobial additives have been limited to the use of conventional biocidal substances released by leaching. Oligodynamic metals such as silver, copper or zinc, their chemical modifications, organic substances such as triclosan and isothiazolinones, and organometallic substances such as zinc pyrithione are used. These substances are stored in a depot in the carrier matrix. Once the depot is exhausted, the antimicrobial effect of the carrier material is no longer present. New developments in the field of antimicrobial additives mostly relate to the production of particles for powder coating, to improved dispersion of biocides in a polymeric carrier matrix, to the prevention of discoloration of the carrier matrix by the added biocides, and to the controlled release of the biocidal active ingredients by encapsulation. However, future-proof antimicrobial systems are expected to exert sufficient spontaneous action to prevent the growth of microorganisms and, at the same time, to be antimicrobially effective over long periods of time by slowly releasing toxicologically and ecotoxicologically tolerable amounts of the active substance.

From WO 2008/046513 A2 a bioactive metallic coating containing silver, ruthenium and a vitamin is known, which is used for sterilization, disinfection and decontamination of water or aqueous solutions. The combination of silver with ruthenium and a vitamin, for example ascorbic acid, leads to faster and more efficient killing of microorganisms. At the same time, these bioactive metal surfaces prevent colonization with microorganisms and the attachment or stable deposition of problematic biomolecules such as DNA, RNA or proteins. The coating creates a self-cleaning surface which, when in contact with water or aqueous solutions, very quickly and efficiently establishes its sterility and maintains it over longer periods of time.

Patent EP 0 677 989 B1 discloses the preparation of an antimicrobially active powder that can be used as an additive for products made of plastic. The powder comprises a core of inorganic material coated with an antimicrobially active metal or metal compound. A second coating consists of aluminum silicate, aluminum oxide, aluminum phosphate, silica, silicate, borosilicate or mixtures of these substances. The porosity of the coating is intended to regulate the diffusion of antimicrobially active substances so as to prevent possible discoloration of the plastics used. A third coating of hydrous metal oxides of aluminum, magnesium, zirconium or the rare earths is intended to reduce the agglomeration of the particles and improve their dispersion in the plastics. The content of the antimicrobial coating is 0.05 to 20 wt% based on the carrier material. For the second coating, the content is 0.5 to 20 wt%, also based on the carrier material. The antimicrobial powder can be added to a variety of aliphatic or aromatic polymers.

EP 0 270 129 A2 discloses a process for the production of an antimicrobial powder based on zeolites and its use as an additive for resins. Both natural and synthetic zeolites are used. The antimicrobial function is based on complete exchange with ammonium ions as well as with ions of the metals silver, copper, zinc, mercury, tin, lead, bismuth, cadmium, chromium and thallium. The metal content is 0.1 to 15 wt% for silver and 0.1 to 8 wt% for copper or zinc. The antimicrobial zeolite is added to resins such as polyethylene, polypropylene, polystyrene or PVC.

Patent US 5 147 686 discloses the production of antimicrobial powders using powdered titanium oxide as a carrier material. The powder particles have a size of 0.01 µm - 3 µm. The particles are provided with an antimicrobially active coating. The coating consists of copper, zinc and their alloys such as Cu—Zn, Cu—Ag, Cu—Sn, Cu—Al, Zn—Sn, Zn—Sn—Cu, Zn—Al—Cu—Mg or similar alloys. The metal content is 0.001 to 35 wt%. The coating is applied by external currentless deposition, whereby the surface of the carrier particles is first activated with palladium or tin. In addition to its antimicrobial properties, the powder excels as an additive in various media.

US 2016/0369405 A1 discloses a method for producing particles coated with metal in a liquid. Particles of silicon, tin, germanium, gallium, lead, zinc, aluminum or carbon are used as the base particles, which are coated with a metal in a reactor, the metal being elemental silver, copper, platinum, palladium, iron, cobalt, rhodium, nickel, vanadium, ruthenium, iridium or gold. A reducing agent, for example ascorbic acid, is used to initiate the plating reaction. In particular, the production and use of silicone particles coated with silver is described.

Materials that are incorporated into products or materials in a particle form in order to ensure or enhance the required product properties are also designed as hybrid systems with different surface compositions and structures in order to integrate them into other materials so that they impart therein their specific particle properties in the desired manner. Multicomponent hybrid particle systems must therefore be specifically adapted to the desired material and the required material properties by the right choice of particle material, particle size and structure, and additionally applied layer systems, or by chemical post-treatment of one or more components of the hybrid particle system. This also applies to particulate systems with antimicrobial properties that are intended to introduce these antimicrobial properties into products or materials. However, there is a risk that during particle processing or particle-material integration, their desired core property - the antimicrobial effect - is weakened or even lost.

### SUMMARY OF THE INVENTION

It is the object of the invention to develop an antimicrobially active particulate hybrid material that can maintain its antimicrobial property even after processing, material integration and/or as an additive in products.

According to the invention, the object is solved by a hybrid material of the type mentioned above, in which the first metal comprises at least one semiconductive compound of at least one transition metal element, which exhibits multiple oxidation states and allows a change of the oxidation states by means of catalytically active centers, and the second metal comprises at least one electrically conductive silver semiconductor, wherein both metals establish half cells which are short-circuited in the presence of water and oxygen and thus develop an antimicrobial, antiviral and/or fungicidal effect, wherein the carrier material comprises at least one material being adapted to the substance and/or the coating material and their use. Overall, the invention thus provides a hybrid, adaptable particulate multi-component system of different materials that can transport its broad-spectrum antimicrobial effect (for the sake of simplicity, the efficacy against bacteria, viruses, fungi, and other microorganisms is hereinafter referred to as “antimicrobial”) into a wide variety of materials, substances and/or coating materials without losing the antimicrobial property in the molding process, material integration or the ready-to-use product. The material components needed for the molding process or material integration and use of the finished antimicrobial product, in particular the carrier material, are selected in such a way that they do not negatively affect the antimicrobial property of the hybrid particulate system, but rather strengthen it. Furthermore, the hybrid material according to the invention is an antimicrobially active particulate system which, adjustable via the hybrid particle structure, is suitable for use with different products or primary materials or substances and/or coating materials. In this context, the hybrid material according to the invention can, for example, be integrated into the substance and/or the coating material. The combination with the hybrid particle system imparts an antimicrobial property to the product or primary material, wherein the carrier material comprises at least one material which is selected, designed and/or modified in such a way that the hybrid material according to the invention is optimally adapted to the substance and/or the coating material and its use. Thus, in addition to maintaining the antimicrobial effect, a further advantage of the hybrid material according to the invention is that it can be specifically adapted to the material, the substance and/or the coating material and the required material properties as well as the desired applications thereof, for example, by the correct selection of the particle material, the particle size and structure as well as additionally applied layer systems or by chemical post-treatments of one or more components of the hybrid particle system.

According to the invention, two metals with high chemical stability and different electrochemical potentials are deposited on the carrier material. Preferably, these are transition metals of the d group, preferably noble metals. The metal combination according to the invention is deposited on the carrier material in such a way that both metals are in electrically conductive contact with each other and are distributed on the surface of the carrier material in the form of a plurality of nano- or microgalvanic elements short-circuited via the aqueous phase. Thus, the present invention advantageously comprises an antimicrobially active metal coating each consisting of a semiconductive, catalytically active transition metal compound (half cell I of a galvanic element) and a semiconductive, hardly soluble silver compound (e.g., silver oxide, silver hydroxide, silver sulfide, silver-halogen compounds, or combinations thereof; half cell II of the galvanic element), both being in direct, electrically conductive contact with each other. The transition metal element of the first half cell is selected in such a way that it has several oxidation states and thus permits a (relatively easy) change of oxidation states via catalytically active centers. Particularly suitable half cells are therefore those which have multiple valences and at which highly reversible redox reactions can occur over a wide potential range. The high catalytic activity of such half cells for oxygen reduction is due to the easy change of oxidation states and the easy exchange of oxygen, which preferentially occurs at the active centers of the semiconductor surface. In this process, the transition metal element is only changed in its valence, resulting in the actual redox reaction. Therefore, no transition metal compound is consumed or formed, only the oxidation states are changed. The transition metal compound binds the molecular oxygen, allowing it to be catalytically reduced. Therefore, the presence of multiple valences is a prerequisite for the catalytic effect and the redox reaction. Thus, no transition metal compound needs to be formed. Special metal oxides or metal sulfides and hardly soluble silver compounds exhibit catalytic properties, electrical conductivity and high stability in water. By suitable combination of materials, two metals are in electrical contact with each other, which have a different electrochemical potential and thus form a galvanic cell. If this cell is short-circuited via the aqueous phase, a high electric field strength is generated due to the small distance (nm or µm range) between the two contacting metals. This contributes significantly to germ elimination. Redox reactions occur at both electrodes of the microgalvanic element, each of which kills the microorganisms. At the first half cell (cathode), molecular oxygen is reduced to oxygen radicals, which then have a toxic effect on the microorganisms. At the second half cell (anode), electrons are transferred from the microorganisms to the silver semiconductor, thereby destroying them by oxidation.

The electrochemical potential difference of the transition metals of the hybrid system deposited on the carrier material is thereby adjusted in such a way that the oxygen present in the moist environment can be reduced by redox processes and antimicrobially active oxygen radicals can be formed. The hybrid antimicrobial particle system according to the invention, whose antimicrobial efficacy is not based on the release of biocides or metal ions but on the catalytically assisted generation of oxygen radicals, preferably on a noble metal combination of silver oxide / ruthenium oxide and/or silver chloride / ruthenium oxide, does not change its composition even with long-term antimicrobial use and, unlike biocides or oligodynamic metals, does not require a depot or devices regulating the biocide or metal ion release.

The two metals (half cells) can, for example, be applied as a layer system on the surface of the particulate carrier (carrier material), with the layer of one metal lying at least partially above that of the other metal. In this case, the respective upper layer can be porous (in particular nanoporous) or microcracked, in particular cluster-shaped, applied to or deposited on the other metal, so that the aqueous solution or moisture has access to both half cells and the galvanic element is short-circuited. Alternatively or additionally, however, the two metals (half cells) can also be applied to the surface of the particulate carrier (carrier material), for example, in the form of individual particles. These may be, for example, bimetallic particles comprising both metals and/or metal particles each comprising only one of the two metals. The latter can be applied sequentially, i.e. first particles of the first metal and then particles of the second metal (or vice versa), or simultaneously as a mixture of particles of both metals in such a way that they are in electrically conductive contact with the carrier material. The particles can be applied to the carrier material in a single layer (lying next to each other) and/or at least partially in multiple layers (lying on top of each other).

Unlike biocides and oligodynamic metals, which have to release toxic substances into the environment in order to be effective, only water is ultimately produced from the oxygen radicals formed when the hybrid material of the invention is used. Since the metal combination is a catalytically supported system, its antimicrobial effect is advantageously dependent exclusively on the active surface and not, as in the case of biocides or the oligodynamic systems (silver, copper and zinc or their salts or compounds), on their quantity and rate of leaching.hg

In an advantageous embodiment of the invention, it is provided that the carrier material comprises at least one material selected from the group consisting of cellulose, glass, zeolite, silicate, metal or a metal alloy, metal oxide (e.g. TiO₂), ceramic, graphite, and a polymer. The hybrid material according to the invention can be targeted by the selection of the carrier material with respect to integration requirements with other materials as well as specific applications of use. For example, in terms of temperature resistance when integrated into e.g. plastics (e.g. silver particles as carrier), water absorption/absorbency (e.g. cellulose as carrier), magnetic particles, e.g. for analytical or production applications in apparatus from which particle removal is only possible from outside with a magnet (iron particles as carrier), cellulose integration in a Lyocel process in which the cellulose doped with the hybrid material of the invention dissolves in the organic cellulose solution and finely distributes the hybrid material particles in the cellulose slurry from which cellulose filaments can then be spun, or color design (e.g. white color: carrier cellulose). Surprisingly, in one of the embodiments of the antimicrobial hybrid system according to the invention, the selection of cellulose as a carrier material has provided a new manufacturing opportunity for antimicrobial textile fibers and films.

For example, cellulose (C)- or its derivatives as microcrystalline (MCC) or nanocrystalline cellulose powder (NCC) can be used as a carrier material, which provide a number of inherent properties that support the antimicrobial effect of the hybrid particle system, such as their hydrophilicity and a high water binding capacity, which is still about 5-8% in the dry state. The cellulose fibers can be varied not only in fiber length but also in fiber cross-section, which can significantly increase the fiber surface area. Thus, in addition to the “standard cellulose” which is cloud-shaped in cross-section, fibers with star-like (Trilobal) or letter-like (Umberto) cross-sections are also available. The cellulose carrier surface can also be significantly increased by so-called bacterial cellulose (BC) due to its tissue-like, fine network structure. BC also has an increased water absorption capacity and is therefore popular in medical applications.

Cellulose is the most abundant biopolymer on earth, with a formation rate of 1.5 trillion tons per year, making it the world’s most important renewable raw material.

Cellulose is used not only in the textile, paper and building materials industries, but also in the medical sector. The widespread use of cellulose materials, particularly their use in medical applications, has led to the development of antimicrobial cellulose particles. Cellulose itself does not have antimicrobial activity that could prevent infections. The majority of work to date on the production of antimicrobial cellulose has focused on the incorporation of biocidal nano-silver particles onto or into cellulose fibers through various deposition processes. Surprisingly, the present invention has succeeded in depositing not only silver but also ruthenium on the cellulose in an adherent manner. In this context, it was achieved in the manner according to the invention that the catalytically supported oxygen radical formation on the silver-ruthenium precipitates is also given on the cellulose carrier.

In a further advantageous embodiment of the invention, it is provided that the hybrid material is modified with organic polymers, preferably polyethylene glycol (PEG), polydopamine and/or chitosan, and/or with ascorbic acid or ascorbic acid derivatives. In this context, the modification can be carried out by pretreating the carrier material before applying the metals, for example to facilitate coating, and/or posttreating the hybrid material after applying the metals. In this way, certain properties of the product (material and/or coating material) doped with the hybrid material according to the invention can be changed or improved. For example, the flowability and/or dispersibility of particles or powders can be specifically adjusted by post-treatment of the hybrid material with, for example, polydopamine or propylene glycol (PG).

In an advantageous embodiment of the invention, it is further provided that the strength of the antimicrobial effect is specifically adjustable through adjusting the amount of at least one of both metals and/or the proportion of both metals on the surface of the particles. Thus, the antimicrobial strength of the selected antimicrobial hybrid material is adjustable not only by varying the amount of particles but also by varying its structure. The hybrid system according to the invention can be specifically adjusted with respect to the strength of its antimicrobial effect (often the highest effect is not desired, adjustment by growth curves) and the requirements for use or integration with other material(s) as well as for the specific applications of use. For example, by varying the coating process, the thickness of at least one metal layer can be adjusted. For example, the shape of the carrier material and/or the reduction process during coating can be used to selectively influence the structure of the metal layers. Furthermore, the strength of the antimicrobial effect of the hybrid material according to the invention can be specifically adjusted, for example, by using a defined amount of at least one metal (e.g. proportion of the metal in the total hybrid material in % by weight).

In another advantageous embodiment of the invention, it is provided that the transition metal element is at least one metal of the group consisting of ruthenium, iridium, vanadium, manganese, nickel, iron, cobalt, cerium, molybdenum, and tungsten.

In a particularly advantageous embodiment of the invention, it is provided that the transition metal compound of the first metal comprises ruthenium present in one or both of the oxidation states VI and IV. Ruthenium is a noble metal that has multiple oxidation states and is capable of forming, for example, different ruthenium oxides due to its different valencies. Surface redox transitions such as Ru(VIII)/Ru(VI), Ru(VI)/Ru(IV), Ru(IV)/Ru(III), and possibly Ru(III)/Ru(II) are the cause of the high catalytic activity of the mixed ruthenium compounds and their good electrical conductivities. The unusually pronounced catalytic and electrocatalytic properties of the ruthenium compounds depend on the variation of the oxidation states. For example, the antimicrobial activity is particularly high in compositions according to the invention comprising ruthenium (VI) oxide in the first half cell.

The transition metal compound of the first metal may thereby comprise at least one corresponding metal oxide, metal oxyhydrate, metal hydroxide, metal oxyhydroxide, metal halogenide and/or at least one metal sulfide of the transition metal element.

In an advantageous embodiment of the invention, it is further provided that the silver semiconductor comprises at least one silver oxide, silver hydroxide, silver halogenide or silver sulfide, or a combination of silver and a corresponding silver compound (for example, metallic silver having on its surface a silver compound such as silver oxide or silver chloride).

In a further advantageous embodiment of the invention, it is provided that the particles have a spherical or polyhedric shape and a mean diameter of at most 100 µm, preferably at most 50 µm, in particular at most 5 µm. For example, such spherical particles may have a mean diameter between 0.1 and 70 µm, preferably between 0.1 and 50 µm or 0.1 and 10 µm, in particular between 1 and 5 µm. Alternatively or additionally, the particles may have a fiber-like shape and a mean length of at most 1 mm, preferably at most 100 µm, in particular at most 75 µm or at most 60 µm. For example, such elongated particles may have a mean length between 0.1 and 100 µm, preferably between 0.1 and 50 µm or 0.1 and 10 µm, in particular between 0.1 and 1 µm. Particle size and shape play an important role, for example, in nozzle problems during the spinning of polymer threads (e.g. fine silver particles) or when a large surface area is required (e.g., due to different cellulose fiber cross-sections or fine silver particles). Since the antimicrobial effect of the hybrid material according to the invention is based on a catalytic process at the particle surface, the particle efficiency increases while the surface fraction of the particles increases in relation to the particle volume. Therefore, particle efficiency is particularly advantageous for smaller particle sizes.

The invention is further solved by a method for producing a hybrid material having antimicrobial activity, in particular the hybrid material described above, comprising the following steps:
a) providing or producing a particle-shaped carrier material,
b) at least partly applying a first metal onto the carrier material, and
c) at least partly applying a second metal onto the carrier material and/or the first metal, wherein both metals are applied such that they are, at least with their respective surfaces, in electrically conductive contact to each other.

In principle, all the materials initially mentioned can be used as carrier materials, preferably cellulose, metals, metal oxides (e.g. TiO₂), glass, ceramics, graphite and polymers. In a particular embodiment, the antimicrobial hybrid system is provided with a magnetizable particle core. For example, the antimicrobial coating may be deposited on a ferromagnetic core (e.g., nickel, iron, cobalt powder). Such antimicrobial hybrid systems are needed, for example, where, after use of the particles, their complete removal from reaction or analytical vessels that are difficult to access is required. The antimicrobial, magnetizable particle hybrids can be pulled from outside the reactor with a strong magnet to an accessible location of a reactor where they can be removed.

Preferably, a first metal is applied to the carrier material, which comprises at least one electrically conductive silver semiconductor. A second metal is also applied to the carrier material and/or the first metal, wherein the second metal comprises at least one transition metal element that has multiple oxidation states and allows a change of oxidation states via catalytically active centers. Alternatively, a first metal can be applied to the carrier material, which comprises at least one transition metal element that has multiple oxidation states and allows a change of oxidation states via catalytically active centers. In this case, a second metal is also applied to the carrier material and/or the first metal, the second metal comprising at least one electrically conductive silver semiconductor. In both alternatives, the second metal is applied to the carrier material and/or the first metal in such a permeable manner that the two metals are in electrically conductive contact with one another at least with their respective surfaces and are each in contact with an electrolyte and can thereby develop an antimicrobial effect (see above).

For the production of a hybrid material according to the invention, for example, silver can be deposited chemically-reductively on the carrier material (e.g. glass beads). Silver nitrate (AgNO₃) is preferably used as the silver salt. Various reducing agents can be used as reducing agents, for example aldehydes, ascorbic acid, metal hydrides (preferably sodium borohydride), hydrazine and/or a hydrazinium salt, and/or hydroxylamine and/or a hydroxylammonium salt. In the case of cellulose as the carrier material, ascorbic acid is preferably used as the reducer. This first step may also be omitted in the case where commercially available silver-coated carrier materials (e.g., pre-silver-coated glass beads) are available and used. Ruthenium, for example, can then also be applied to the silver layer by chemical reduction. For ruthenium coating, the silver-coated carrier material (e.g. glass beads) is dispersed in alkaline solution under strong stirring. Solutions of ruthenium (III) chloride and sodium borohydride are then added as reducing agents.

In an advantageous embodiment of the method according to the invention, it is provided that at least one of both metals is applied onto the carrier material and/or the respective other metal in cluster-shaped form, nanoporously, microcrackly and/or in the form of single particles.

In an advantageous embodiment of the method according to the invention, it is further provided that, after step a) and/or step c), the carrier material and/or the metals is/are modified with organic polymers, preferably polyethylene glycol, polydopamine and/or chitosan, and/or with ascorbic acid or derivatives of ascorbic acid. Consequently, the hybrid material can be modified by pretreatment of the carrier material prior to application of the metals, for example to facilitate coating, and/or post-treatment after application of the metals. In this way, certain properties of the product (material and/or coating material) doped with the hybrid material according to the invention can be modified or improved. According to the invention, for example, the carrier material with the antimicrobial metal coating, without or with a chemically generated compound layer (see below), can be modified to optimize the properties of the hybrid material. This concerns, for example, the flowability, dispersibility or long-term stability. According to the invention, despite the modification of the hybrid particle system, its antimicrobial properties are maintained or even improved.

In a further advantageous embodiment of the method according to the invention, it is provided that a link layer is generated on at least one metal, which comprises at least one metal compound of the corresponding metal, which is selected from the group consisting of halogenides, oxides, and sulfides. To enhance the function, the two metals are thereby activated with a chemically stable compound of the metals. For this purpose, a link layer is created on the metals, which may consist of a halide, oxide or sulfide, for example. The influence of the post-treatment of the particulate surfaces can be determined or adjusted accordingly, for example, using suitable microbiological methods or measurement procedures, such as growth curves.

In an advantageous embodiment of the method according to the invention, it is further provided that the strength of the antimicrobial effect is specifically adjusted by adjusting the amount of at least one of both metals and/or the proportion of both metals on the surface of the particles. For example, the strength of the antimicrobial effect of the hybrid particle system can be controlled by appropriately selecting the deposition conditions for the two metals on the surface of the carrier material, wherein the areal proportions of the two metals on the hybrid surface are varied with respect to each other. The surface composition sought for desired antimicrobial action of the hybrid particulate material of the invention can be determined by suitable microbiological methods, such as growth curves, based on the variation of particle composition and structure.

In a further advantageous embodiment of the method according to the invention, it is provided that the respective metal is applied sequentially or simultaneously by means of electrochemical deposition, chemical-reductive deposition, electrophoretic coating, calcinating, PVD, CVD and/or sol-gel processes. In this context, the two metals (half cells) can also be deposited, for example, in the form of individual particles on the surface of the carrier material. The particles can be applied to the carrier material, e.g., sequentially, i.e. first particles of the first metal and then particles of the second metal (or vice versa), or simultaneously as a mixture of particles of both metals (or possibly in the form of bimetallic particles).

In calcination, thermally easily decomposable compounds containing the desired transition metals (usually anhydrous), e.g., in alcohols (e.g., ethanol or isopropanol), are intensively mixed, applied to the surface to be coated and then thermally decomposed at high temperatures (e.g., 200-500° C.) in the presence of air. In this process, any desired composition of the two half cell metals can be adjusted by mixing the two metal salts to obtain the appropriate oxidic compounds. Easily decomposable ruthenium compounds include, for example, RuCl₃ (halides in general).

In a particularly advantageous embodiment of the invention, it is further provided that the application of the second metal onto the carrier material and/or the first metal comprises at least one step having a strong oxidative effect. For example, ruthenium/ruthenium oxides can be applied in a two-step process, wherein in the first step ruthenium is first oxidized and only in the second step the reduction of the oxidized ruthenium to ruthenium and RuOx is accomplished. Unlike the direct, one-step reduction of Ru (III) ions by a strong reducing agent, this indirect, two-step process relies on the oxidation of Ru (III) ions to ruthenium (VIII) oxide (RuO₄). RuO₄ is a strong oxidizing agent that is converted to ruthenium (IV) oxide by suitable reducing agents, coating the carrier material with a layer of ruthenium (IV) oxide. For example, the formation of ruthenium (VI) oxide can be achieved in both electrochemical and PVD deposition of ruthenium if the ruthenium deposition includes a process step with a strong oxidative effect.

In a further advantageous embodiment of the invention, it is provided that, after applying both metals, a thermal post-treatment is accomplished for adjusting specific oxidation states. Provided that the carrier material is thermally resistant, the applied oxidic metal coatings or metal compounds can be subjected to thermal oxidation or reduction in a suitable atmosphere in order to set specific oxidation states.

The invention further relates to a hybrid material with antimicrobial activity produced by means of the method described above.

The invention also relates to the use of the hybrid material according to the invention for joint application with any materials, substances and/or coating materials, preferably lacquers, paints, plasters, polymers and/or cellulose. In this regard, the hybrid material may be associated with the materials, substances and/or coating materials in any manner. For example, the materials, substances and/or coating materials may be coated with or blended with the hybrid material particles. Preferably, the hybrid material particles of the invention are integrated into the materials, substances and/or coating materials.

The hybrid cellulose-silver-ruthenium particle variant of the hybrid material according to the invention surprisingly offers the possibility to produce antimicrobial cellulose fibers and cellulose films based on the antimicrobial hybrid system according to the invention with the help of the innovative and environmentally friendly Lyocell technology, since the cellulose-silver-ruthenium particle additive, despite its catalytic activity, does not have a decisive influence on the decomposition temperature of the solvent used in the Lyocell process (N-methymorpholine N-oxide (NMMO)) and can thus be processed in the Lyocell process. In the Lyocell process, the carrier material cellulose dissolves in the NMMO and releases the silver-ruthenium particles deposited on the cellulose fibers evenly distributed in the cellulose-containing solvent, so that antimicrobial Lyocell fibers can be produced from them for the textile industry, but also for nonwovens and other technical applications such as films, e.g., for packaging.

The invention also relates to microparticles, in particular bimetallic particles, for forming an antimicrobially active powder, which comprise particles of a first metal coated with a cluster-shaped, nanoporous and/or microcracked layer comprising a second metal, the particles of the first metal having an average diameter of at most 50 µm, preferably at most 10 µm. A particular embodiment of the invention is established if one of the two active components (metals) of the hybrid system is both surface and carrier material at the same time. For economic reasons alone, this applies only to very small noble metal carrier particles (e.g. 0.1 - 50 µm, preferably < 5 µm). In processing operations for integrating the hybrid antimicrobial particle system according to the invention (e.g., into certain plastics), which have to take place at high temperatures, this hybrid system variant is an option. For this purpose, the metal particles used as carrier material must be appropriately small so that the costs for the hybrid particle system can be overcompensated by correspondingly smaller amounts of noble metal due to the more favorable surface-to-volume ratio.

In an advantageous embodiment of the microparticles according to the invention, it is provided that the first metal is silver and the second metal is a metal selected from the group consisting of ruthenium, iridium, vanadium, manganese, nickel, iron, zinc, cobalt, cerium, molybdenum, and tungsten, or that the first metal is a metal selected from the group consisting of ruthenium, iridium, vanadium, manganese, nickel, iron, zinc, cobalt, cerium, molybdenum, and tungsten and the second metal is silver.

The invention also relates to a method for the preparation of microparticles, in particular bimetallic particles, having antimicrobial activity, comprising the following steps:
a) Dispersing silver particles having an average diameter of 50 µm or less in an alkaline solution,
b) adding a ruthenium (III) chloride solution and a reducing agent to the dispersion according to step a), and
c) separating the microparticles from the dispersion according to step b).

In an advantageous embodiment of the method according to the invention, it is provided that the reducing agent is sodium borohydride, hydrazine and/or a hydrazinium salt, and/or hydroxylamine and/or a hydroxylammonium salt.

The invention further includes microparticles, in particular bimetallic particles, for forming an antimicrobial powder prepared by the method described above.

The microparticles or bimetallic particles according to the invention can advantageously be used together with any materials, substances and/or coating materials, preferably lacquers, paints, plasters, polymers and/or cellulose. In this regard, the microparticles may be associated with the materials, substances and/or coating materials in any manner. For example, the materials, substances and/or coating materials may be coated or blended with the microparticles. Preferably, the microparticles are integrated into the materials, substances and/or coating materials.

Preferably, the microparticles or bimetallic particles according to the invention are a component of the hybrid material according to the invention, wherein the carrier material is at least partially coated with the microparticles or bimetallic particles.

The microparticles or bimetallic particles according to the invention can thus be used in an advantageous manner to produce a hybrid material according to the invention by applying them to the carrier material. The microparticles can be applied to the carrier material in a single layer (lying side by side) and/or at least partially in multiple layers (lying on top of each other).

The particulate materials of the invention are suitable, for example, for providing coatings and paints, plasters, polymers, textiles and packaging materials with antimicrobial properties. In principle, a wide range of materials such as cellulose, metals or metal oxides (e.g. TiO₂), ceramic/mineral or polymer materials are available as carrier materials. A hybrid antimicrobial particle system is particularly advantageous if, in addition to the active component, the other constituents of the hybrid system can contribute additional positive properties that can support or improve the effect, processing or integration into the desired semi-finished product or finished product.

“Particle”, “particle-shaped” or “particulate” in the sense of the invention refers to single particle-shaped bodies that are delineated as a whole from other particles and their surroundings. In this context, all possible particle shapes and sizes, regardless of geometry and mass, are included within the scope of the invention. Particles may be characterized, for example, by their shape, weight, volume and/or size (e.g., length, diameter, circumference).

“Half cell” in the sense of the invention refers to a part of a galvanic element forming the latter in combination with at least one further half cell. In this context, a half cell comprises a metal electrode which is at least partially located in an electrolyte.

“Galvanic element” in the sense of the invention refers to the combination of two different metals, each of which forming an electrode (anode and cathode, respectively) in a common electrolyte. If the two metal electrodes are in direct contact with each other or are electrically conductively connected to each other via an electron conductor, the less noble metal with the lower redox potential (electron donor, anode) donates electrons to the more noble metal with the higher redox potential (electron acceptor, cathode) and subsequently initiates the redox processes at the electrodes.

“Electrolyte” in the sense of the invention refers to a compound (e.g., ions in aqueous solution) that conducts electric current under the influence of an electric field by the directional movement of ions.

“Substance” in the sense of the invention refers to a material of which a part, component, structural element or assembly of an article or product is made. In particular, the term “substance” includes, but is not limited to, parts made of at least one polymer (plastic; including films as packaging material), textiles (natural and/or synthetic textile fibers; woven, knitted, crocheted and braided fabrics), nonwovens, metals, glass and ceramics.

“Coating material” in the sense of the invention refers to a material or substance with which an object or product is or can be at least partially covered. The coating material may be applied to the object or product in one or more (preferably thin) layer(s). In particular, the term “coating material” includes, among others, liquid or pasty coating materials such as lacquers, paints and plasters, as well as solid coating materials such as powders and films.

“Metal” in the sense of the invention refers to atoms of a chemical element of the periodic table of the elements (all elements that are not nonmetals) that form a metal lattice by means of metallic bonds and thereby a macroscopically homogeneous material that is characterized, among other things, by high electrical conductivity and high thermal conductivity. The term “metal” also includes alloys comprising at least two different metals, metal compounds such as metal oxides, metal oxyhydrates, metal hydroxides, metal oxyhydroxides, metal halides and metal sulfides, and combinations of metals and corresponding metal compounds.

“Layer” or “layered” in the sense of the invention refers to a two- or three-dimensional structure that has a horizontal extension and is bounded by at least two surfaces, the layer bottom and the layer top. In this context, a layer may comprise a coherent material or substance and/or particles that are at least partially in contact with each other. In the sense of the invention, a layer may be homogeneous, heterogeneous, continuous (i.e., uninterrupted), clustered, nanoporous, and/or microcracked. “Coated” in the sense of the invention is a material, particle or other body, if at least a part of its (outer or inner) surface is provided with a “layer” (see above).

The invention is further explained in more detail by the following figures and examples.

### BRIEF DESCRIPTION OF THE FIGURES

FIG. 1 shows a schematic diagram of an exemplary embodiment of the hybrid material according to the invention.

FIG. 2 shows photographic images of different antimicrobial variants of the hybrid material according to the invention prepared on silver-coated glass beads S3000S of the company Potters Industries Inc. with an average diameter of about 40 µm.

FIG. 3 shows REM images of silver-coated glass beads S3000S of the company Potters Industries Inc. at 300x magnification (top left) and at 10,000x magnification (top right). Ruthenium-coated samples are shown at 10,000x magnification: Samples 513 (center left), 514 (center right), 515 (bottom left), and 516 (bottom right).

FIG. 4 shows a bar graph of the catalytic formation of hydrogen peroxide at the surface of the particulate antimicrobial hybrid materials 513, 514, and 515 according to FIG. 3.

FIG. 5 shows a photographic image of an inhibition zone test. A suspension culture of E. coli bacteria (DSM 498) was plated onto an agar plate. Silver-coated glass particles S3000S and antimicrobial hybrid materials 513, 514, and 515 were plated onto the agar as samples according to FIG. 3 and incubated at 37° C. for 18 h. The samples were then added to the agar plate.

FIG. 6 shows growth curves of MRSA cultures (source: Robert Koch Institute) in the presence of the glass particles S3000S and the antimicrobial hybrid materials 513, 514, and 515 according to FIG. 3.

FIG. 7 shows photographic images of exemplary embodiments of the hybrid material according to the invention.
a) Uncoated cellulose powder;
b) coated antimicrobial cellulose powder with a silver content of 20% by weight and a ruthenium content of 1% by weight;
c) distribution of the two metals on the cellulose fiber; and
d) inhibition zone test powder prepared according to the invention.

FIG. 8 shows growth curves of MRSA cultures (source: Robert Koch Institute) in the presence of the hybrid material (powder) according to the invention as shown in FIG. 7.
(a) Determination of the minimum inhibitory concentration; and
(b) dependence of antimicrobial efficiency of cellulose particles on ruthenium content.

FIG. 9 shows photographic images, a bar diagram and a table relating to the antimicrobial efficacy of a cellulose film or yarn produced by a lyocell process.
a) Cellulose film;
b) inhibition zone test for antimicrobial activity of the cellulose filament produced according to the invention against E. coli (DSM 498); and
c) antimicrobial activity of a particulate cellulose-based silver-ruthenium hybrid (720b) against S. aureus (DSM 799).

FIG. 10 shows a graphical representation (curve) of a virus plaque test for the efficacy of one embodiment of the hybrid material according to the invention against SARS-CoV-2 and Feline Coronavirus (FCoV).
(a) Feline coronavirus (FCoV); and
(b) SARS-CoV-2.

FIG. 11 shows photographic images of an exemplary embodiment of the hybrid material according to the invention (microparticles or antimicrobial powder).
a) Uncoated silver powder;
b) antimicrobial powder coated according to the invention;
c) REM image of a powder particle at 100,000x magnification.
d) Inhibition zone test for antimicrobial activity of the microparticles or powder according to the invention.

FIG. 12 shows a growth curve of MRSA for microparticles according to the invention as shown in FIG. 11b.

FIG. 13 shows photographic images of a further exemplary embodiment of the hybrid material according to the invention (microparticles or antimicrobial powder) on a catalytic basis.
a) Powder after filtration, washing and drying;
b) mortared, black powder;
c) REM image of a powder particle at 100,000x magnification; and
d) inhibition zone test for antimicrobial activity of the microparticles or powder according to the invention.

FIG. 14 shows a growth curve of the microparticles or powder according to FIG. 13.

FIG. 15 shows photographic images of several samples of commercial facade paint, to which increasing concentrations (0.1 wt.%, 0.5 wt.% and 1.0 wt.%) of an exemplary embodiment of the hybrid material according to the invention prepared on glass particles have been added.

FIG. 16 shows photographic images of several samples of a commercial antifouling paint to which increasing concentrations (2.0 wt%, 4.0 wt% and 8.0 wt%) of another exemplary embodiment of the hybrid material according to the invention prepared on cellulose powder have been added.

FIG. 17 shows photographic images of Ultramid C33 samples containing 1 wt% of an exemplary embodiment of the hybrid material of the invention prepared with commercial silver powder.
a) Granules;
b) plates; and
c) inhibition zone test of the samples against E. coli bacteria.

FIG. 18 shows a photographic image of fibers of polyamide containing 3 wt% of an exemplary embodiment of the catalytic-based hybrid material of the invention (a) and a bar diagram of the antimicrobial efficacy of these fibers (b).

FIG. 19 shows photographic images of an antimicrobial hybrid material prepared according to the invention, the core of which consisting of ferromagnetic iron powder (a and b), as well as a bar diagram showing the lysis of gram-positive B. subtilis germs by this hybrid material (c).

FIG. 20 shows photographic images of an exemplary embodiment of the hybrid material according to the invention, which is uniformly distributed in the water by vigorous stirring.
a) Particles of the hybrid material without post-coating; and
b) particles of hybrid material subsequently treated with dopamine hydrochloride solution (2 mg/ml) and phosphate buffer (0.1 M, pH 8.5) at RT.

FIG. 21 shows a photographic image of an inhibition zone test for the antimicrobial efficacy of an exemplary embodiment of the cellulose-based hybrid material according to the invention, the efficacy of which is not impaired by post-treatment.

FIG. 22 shows photographic images of a cellulose-based antimicrobial hybrid material that has been integrated into siloxanes to provide them with antimicrobial activity.
a) Siloxane coatings H 2084 and H 5055; and
b) antimicrobial assay results for E. coli on an agar with polypropylene platelets coated on one side with siloxane.

FIG. 23 shows growth curves of MRSA bacteria using two ruthenium / ruthenium oxide // silver / silver chloride (Ru/RuOx // Ag/AgCI) powders (AP 383 and AP 823) prepared by different ruthenium deposition processes for different powder amounts.

FIG. 24 shows an XPS surface analysis (Ru3d spectra) of the electroplated Ru/RuOx // Ag/AgCl powder samples 825 and 392 and the Ru/RuOx // Ag/AgOx PVD coatings on polyethylene films (samples Ru and RuOx).

FIG. 25 shows O1s spectra for samples 825, 392, Ru, RuOx.

### DESCRIPTION OF EXEMPLARY AND PREFERRED EMBODIMENTS OF THE INVENTION

According to the invention, the particulate hybrid material is produced on the basis of a core substance (carrier material), whereby, for example, a first closed layer with one of the two electrode metals according to the invention is first applied to the core material (cellulose, metal, glass, ceramic, graphite, polymer). Subsequently, the second electrode metal is applied as a non-closed, cluster-shaped, porous or micro-cracked thin second layer on the core material and/or the first electrode layer. These coatings can be applied by conventional electrolytic processes, chemically-reductive processes, or via vapor deposition. Preferably, chemical-reductive processes are used, in which the metals are deposited on the selected carrier material by chemical reduction. Suitable reducing agents include aldehydes, ascorbic acid, hydrazine, hydroxylamine or metal hydrides. To prevent the reducing agent from depositing the metal ions already in solution rather than on the particle cores, which would decompose the solution and result in metal loss, suitable inhibitors known to experienced electroplating personnel can be added to the electrolyte. In ruthenium deposition, for example, ethylenediamine can be added as a suitable inhibitor. Depending on the reducing agent used, the surface of the carrier material must be activated with a catalyst. Since silver causes the decomposition of sodium borohydride, no additional activation is necessary for this combination.

The deposition of the two metals on the carrier material can be carried out, for example, in a two-stage process, since both metals can usually be deposited galvanically from electrolytes with different compositions. Preferably, the chemical-reductive metal deposition is carried out batchwise, with the amount of metal contained in the electrolyte being completely deposited on the particle cores. Verification of the complete elaboration of the electrolyte can be performed by classical analytical methods, such as AAS or ICP, which is essential not only for quality control, but especially when precious metals are used as antimicrobial coating materials. In order to achieve uniform and complete deposition of the metals on the particle cores, the metered addition of the metal compounds, reducers as well as other chemical additives into the reactor must be carried out with simultaneous high electrolyte movement, e.g. by stirrers or mixers (kneaders in the case of cellulose). Temperature control or cooling and classical electrolyte controls such as measurement of the pH value are important for quality assurance of the hybrid antimicrobial particles as well as process reliability.

Post-coating of the antimicrobial hybrid material is carried out in separate reactors, for example by adding it with uniform stirring to an aqueous solution containing the reactant. In this process, a chemical reaction or chemisorption takes place on the surface of the metals on the hybrid material of the invention at the metal surface of the hybrid system, for example, by using halide- or sulphide-containing water-soluble compounds, ascorbic acid, chitosan, polyethylene glycol, polydopamine .

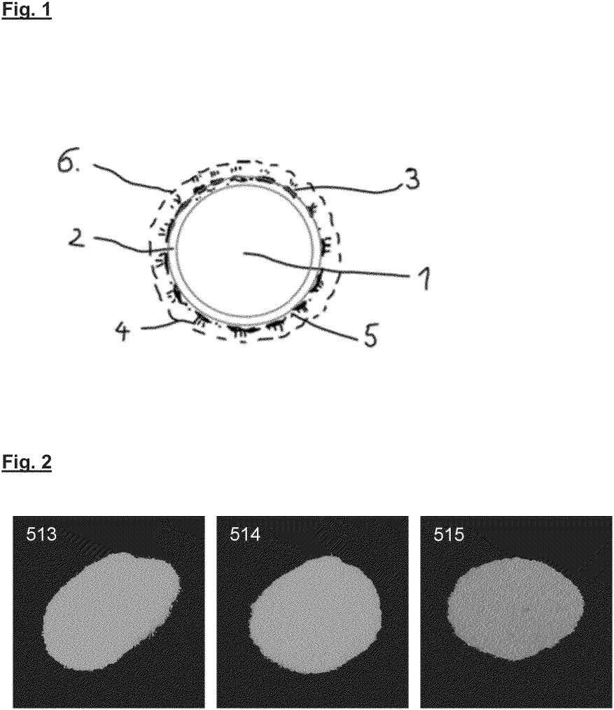

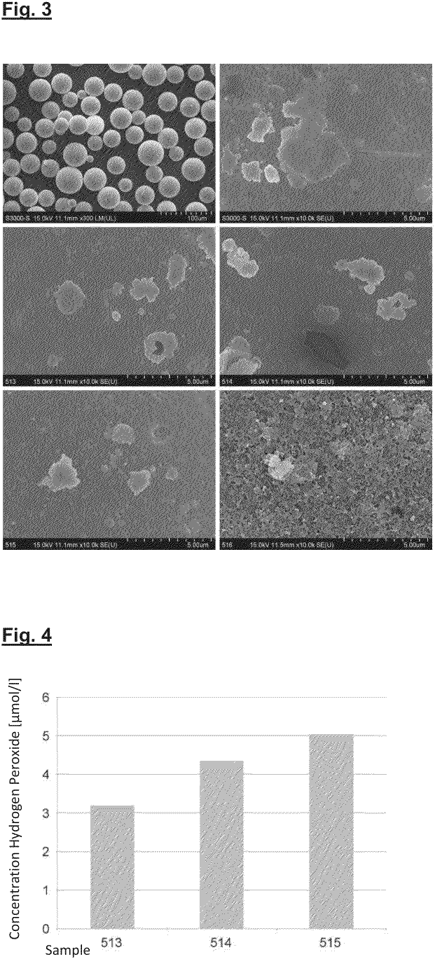

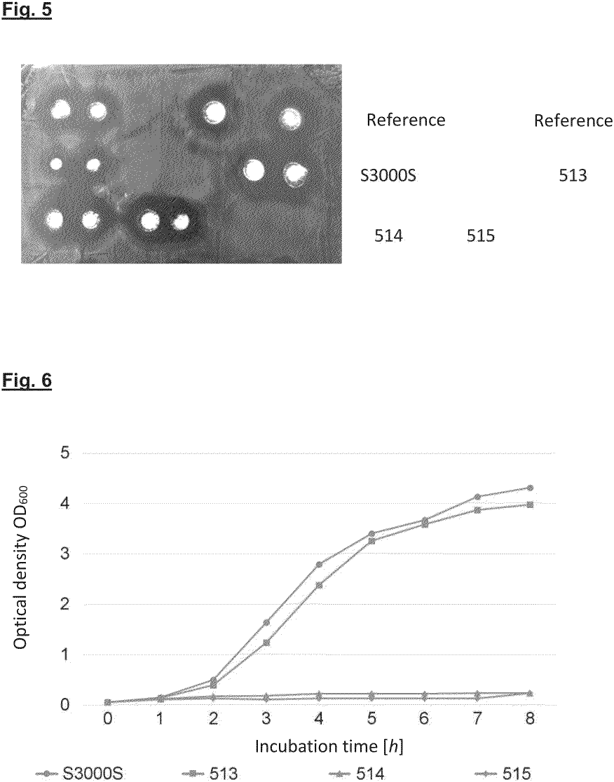

FIG. 1 schematically shows the structure of the particulate antimicrobial hybrid material, the shape and size of which are largely determined by the particle core (1). The particle size is usually < 50 µm, preferably < 5 µm. In the case of fibrous particles, the linear extension, depending on the application, can be < 1 mm, preferably < 60 µm, preferably, < 1 µm.

A first, largely closed metal layer (2), preferably a silver layer, is applied to the core (1).

Over the first layer (2) of the hybrid system, the second metal, preferably ruthenium, is applied as a very thin nanoporous layer (3). First (2) and second layer (3) over the core (1) are constructed in such a way that oxygen from the moist environment, is reduced at the cathodic part of the applied material of the hybrid surface and oxygen radicals are formed.

The metallic components of the first (2) and second layer (3) can each be converted by chemical reactions at the surface into a metal compound (4), e.g. a metal halide or metal sulfide, or form an oxide layer by an oxidizing solution, or convert an existing oxide layer into a mixed oxide layer with altered valencies. The hybrid layer system on the particles can alternatively be provided with a chemisorbed ascorbic acid layer (5).

The hybrid system can additionally be provided with a polymeric layer (6) of chitosan, polyethylene glycol or polydopamine, which do not inhibit the antimicrobial effect.

Depending on the required property profile, the chemically-reductively deposited metals and chemically applied inorganic or organic layers can be variably adjusted in their lateral distribution, thickness and structure.

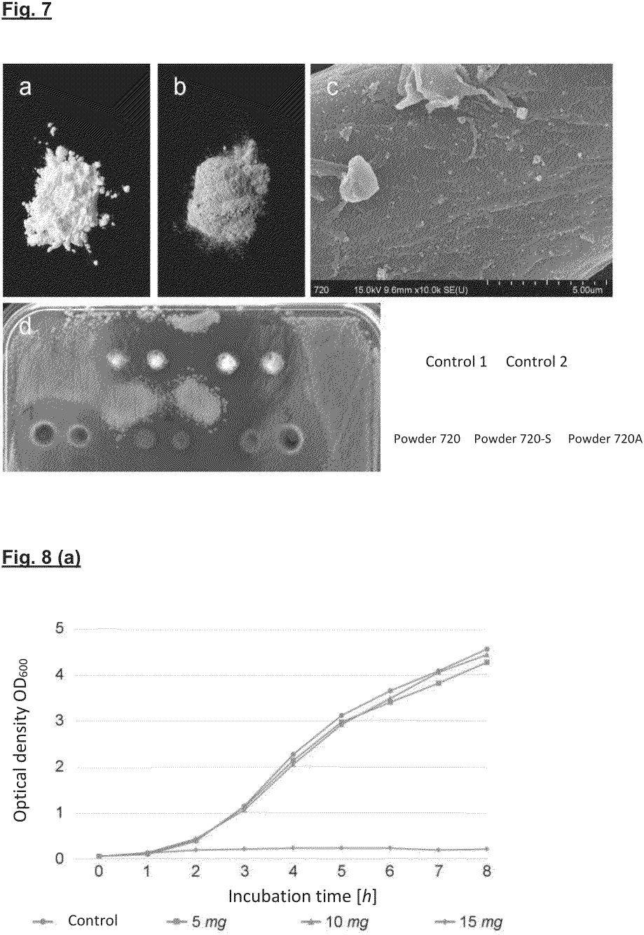

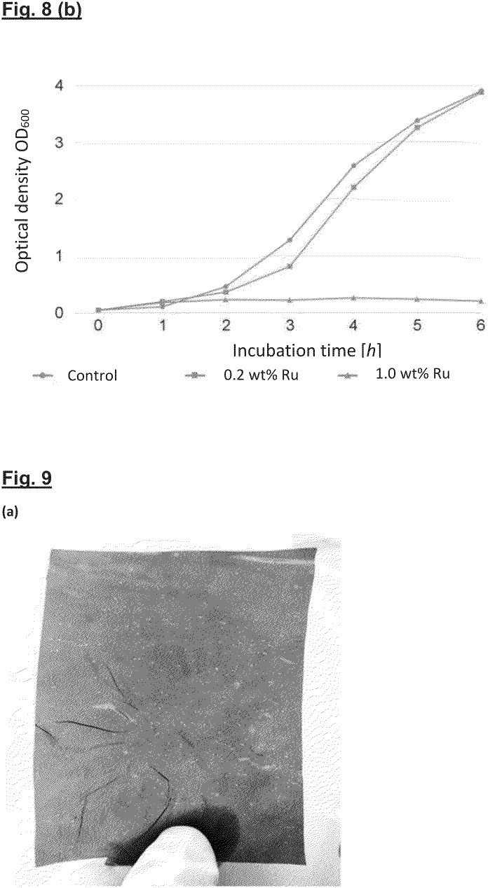

FIG. 2 shows different antimicrobial variants of the hybrid material according to the invention prepared on silver-plated glass beads S3000S from Potters Industries Inc. with an average diameter of approx. 40 µm. Silver serves here as the anode material, on which ruthenium was deposited with different layer thicknesses as the catalytically active cathode material. For the ruthenium coating, the glass spheres were dispersed in alkaline solution with vigorous stirring. Then solutions of ruthenium (III) chloride and sodium borohydride were added as reducing agents. Particles with different layer thicknesses of ruthenium were prepared. The calculated average layer thickness of ruthenium is about 0.4 nm for sample 513, about 0.8 nm for sample 514, and about 1.9 nm for sample 515. The surface of the samples becomes slightly darker with increasing layer thickness of ruthenium. Sample 515 exhibits a faint brownish hue.

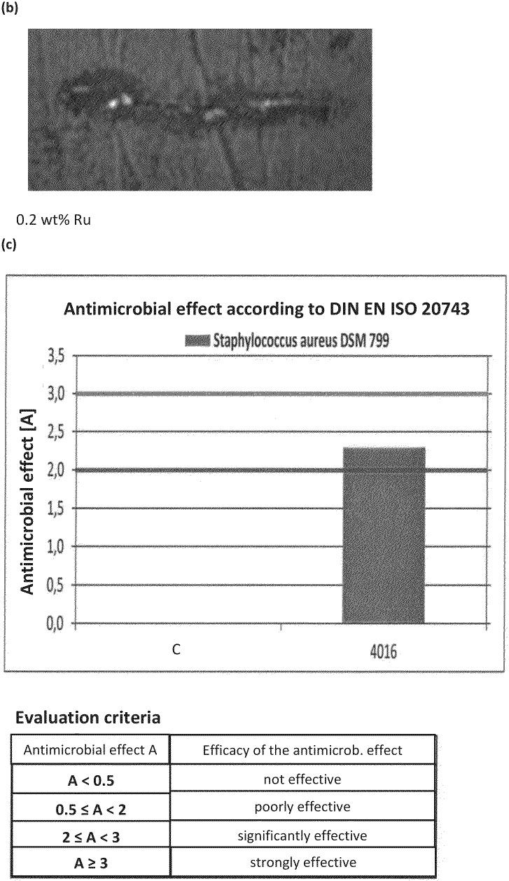

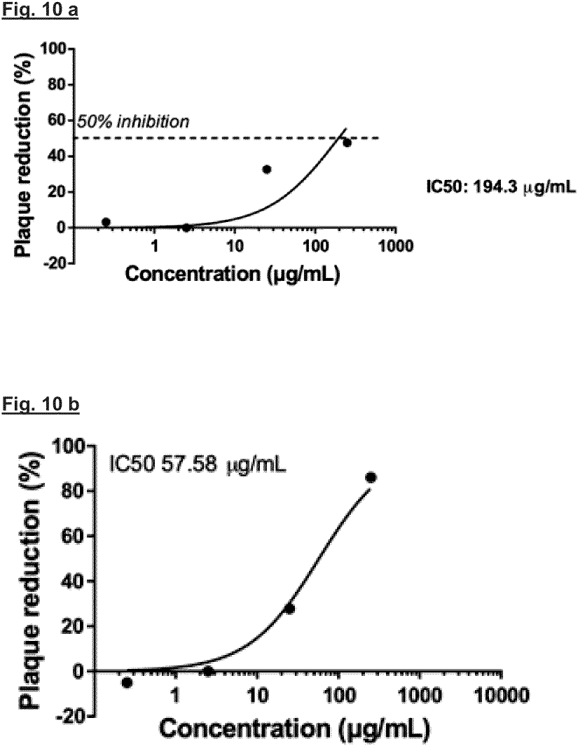

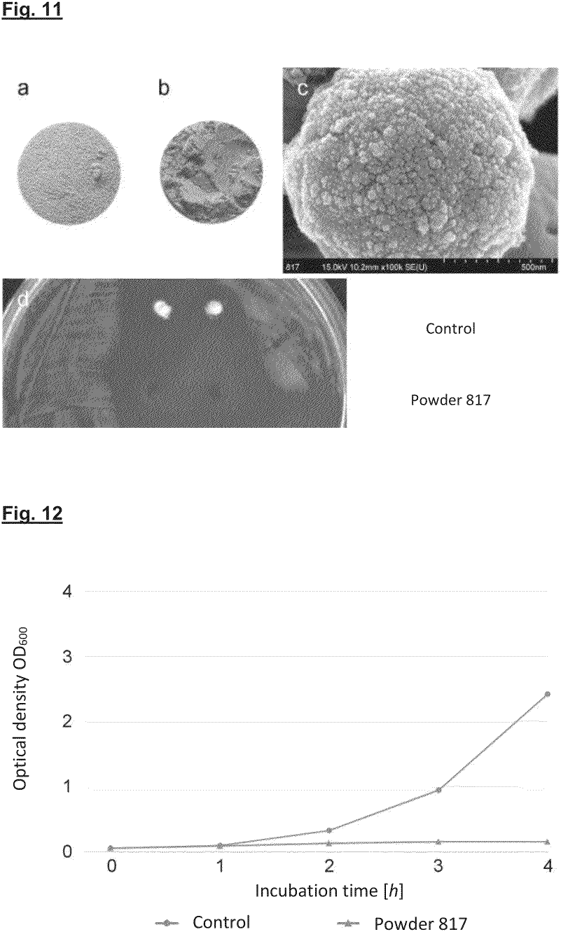

FIG. 3 shows SEM images of the chemically-reductively coated particles. The silver-coated glass particles S3000S are shown at 300x magnification (top left) and at 10,000x magnification (top right). Furthermore, samples coated with ruthenium are shown at 10,000x magnification. Samples 513 (middle left), 514 (middle right) and 515 (bottom left) show a very uniform coating. For sample 516 (bottom right) with an average coating thickness of about 9.4 nm, the porous structure of the catalytically active ruthenium coating can be seen.

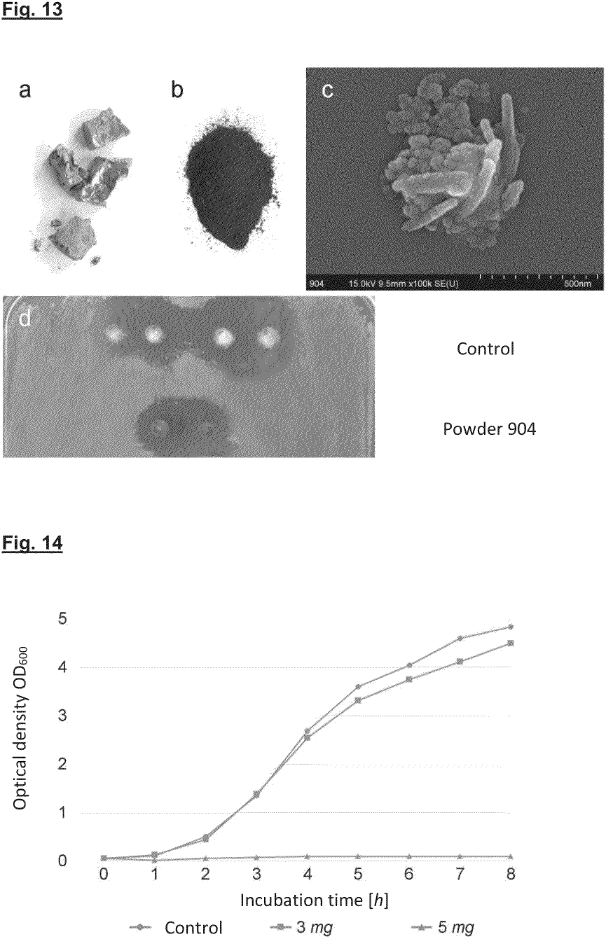

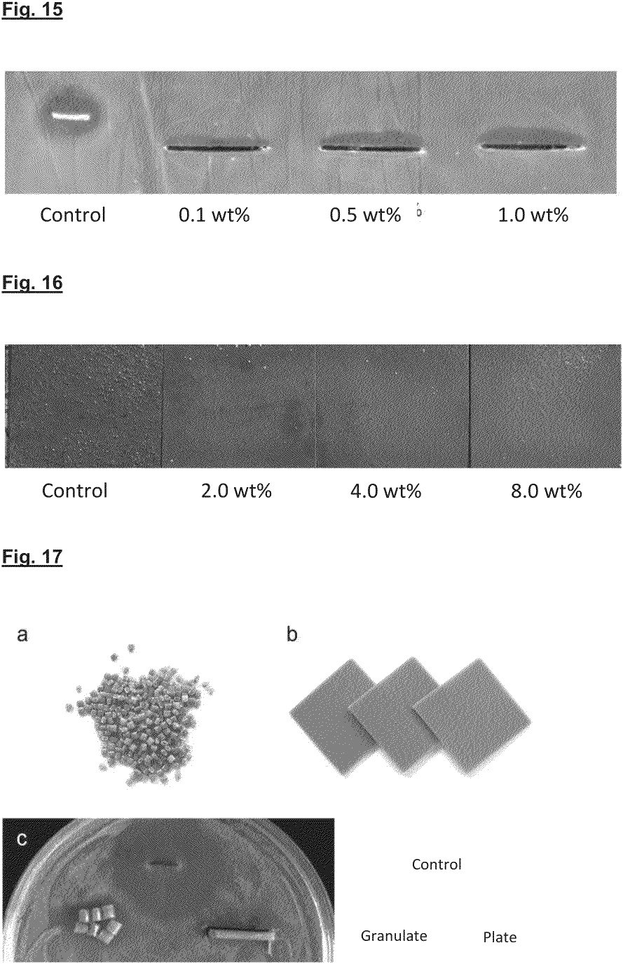

FIG. 4 shows the catalytic formation of hydrogen peroxide on the surface of particulate antimicrobial hybrid materials 513, 514, and 515. 50 mg of each bead was incubated in a solution of ferrous ions and xylenol orange for 1 h on the shaker at 225 rpm. The iron (II) ions were oxidized by the formation of hydrogen peroxide. The generated ferric ions immediately formed a colored complex with xylenolorange, the concentration of which was determined photometrically at a wavelength of 585 nm. As the thickness of the ruthenium layer increases, the concentration of hydrogen peroxide formed increases.

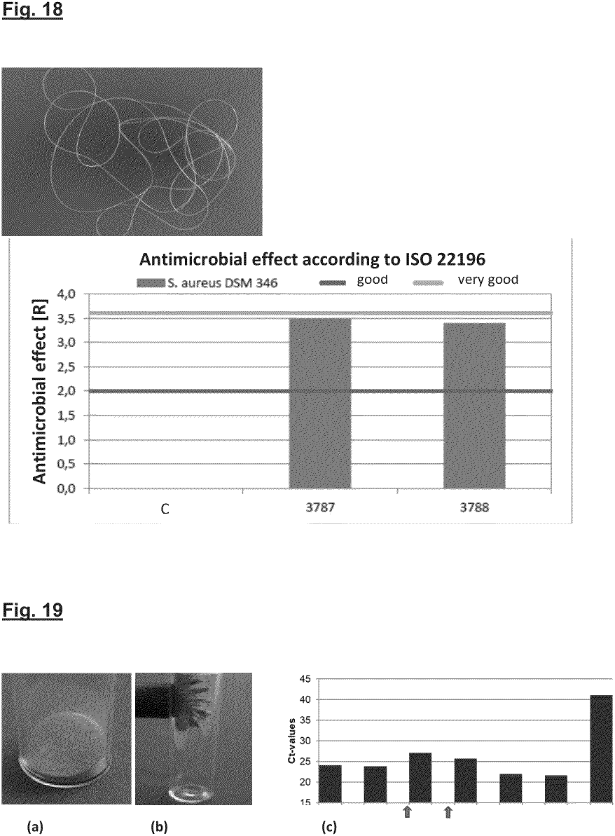

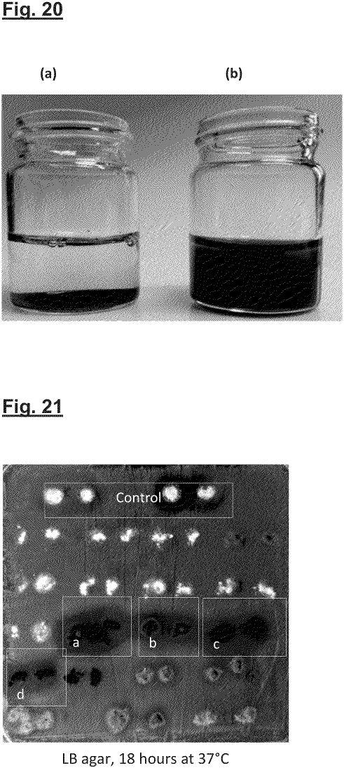

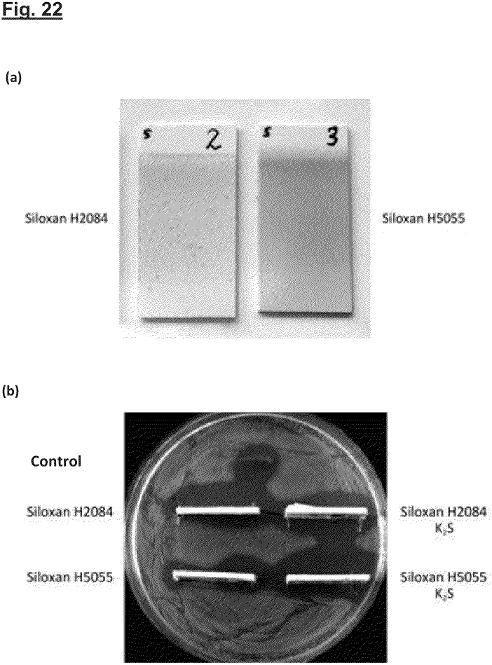

FIG. 5 shows the determination of the antimicrobial efficiency of the powder samples after the inhibition zone test. A suspension culture containing 10⁷/ml bacteria of E. coli (DSM 498) was plated out with 50 µl. The samples were plated on the agar and incubated for 18 h at 37° C. The silver-coated glass particles S3000S already showed moderate antimicrobial activity. The antimicrobial efficiency of powders 513, 514 and 515 is very high. A difference between these samples is not discernible after microbiological agar testing.

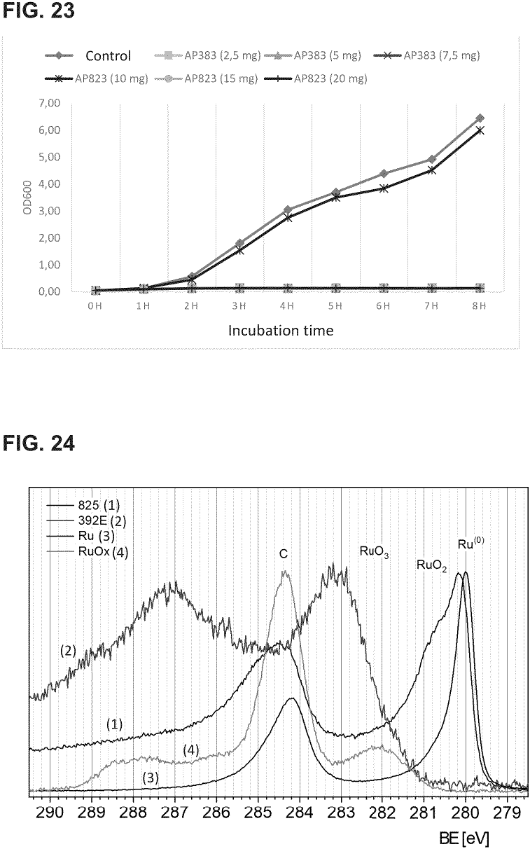

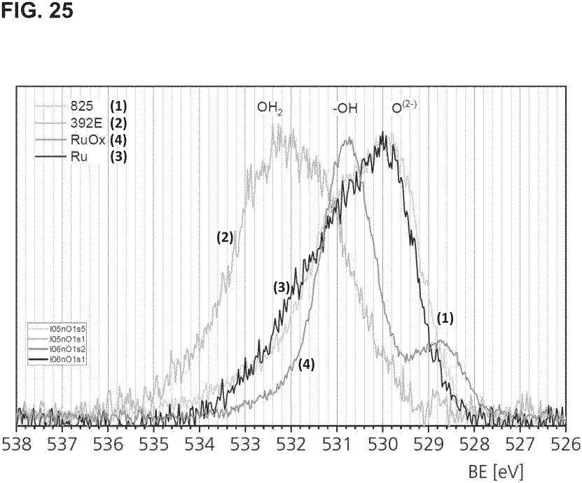

FIG. 6 shows growth curves of the powders S3000S, 513, 514 and 515. 30 ml of a culture of MRSA (source: Robert Koch Institute) was adjusted to an optical density of 0.1 in an Erlenmeyer flask. Subsequently, 200 mg of each of the different samples were incubated in a shaking incubator at 37° C. and 150 rpm. The optical density (OD₆₀₀) of the samples was then determined at hourly intervals. No inhibition of MRSA culture growth was determined for the silver-coated glass beads after this very sensitive antimicrobial assay method. With increasing layer thickness of ruthenium on the beads, the growth inhibition increases significantly. For sample 515, complete growth inhibition is observed for the selected weight of powder. The minimum inhibitory concentration (MIC) for this powder is thus 200 mg.

FIG. 7 shows an antimicrobial particulate hybrid material prepared on the basis of cellulose powder with an average fiber length of 60 µm. The cellulose powder was first impregnated with a solution of silver nitrate. Then the silver ions were reduced by adding ascorbic acid. Gray-white silver-coated cellulose powder was obtained. The silvered cellulose powder was then dispersed in alkaline solution with vigorous stirring. Then solutions of ruthenium (III) chloride and sodium borohydride were added as reducing agents. Dark gray powder was obtained, the color of which depends largely on the ruthenium content. FIG. 7a shows the uncoated cellulose powder and FIG. 7b shows the coated antimicrobial powder with a silver content of 20 wt.% and a ruthenium content of 1 wt.%. The SEM image of the fiber surface at 10,000x magnification shown in FIG. 7c shows the uniform distribution of the two metals on the cellulose fiber. The inhibition zone test according to FIG. 7d shows that various batches of the powder produced by this process have high antimicrobial activity.

FIG. 8 a shows the determination of the minimum inhibitory concentration of the antimicrobial powder on coated cellulose by generating MRSA growth curves. A sample without addition of the antimicrobial powder served as a control. The minimum inhibitory concentration for the prepared powder was only 15 mg. FIG. 8 b shows that the antimicrobial efficiency of the prepared cellulose-based antimicrobial particles also depends on its ruthenium content. For a ruthenium content of 0.2 wt%, only a slight inhibition of bacterial growth of MRSA can be seen according to the growth curve determined, while for a ruthenium content of 1.0 wt%, complete inhibition of growth occurs. A sample without addition of the antimicrobial powder again served as a control. The weight of the powders was 20 mg in each case.

Although all hybrid silver-ruthenium particles on cellulose carrier material exhibit an antimicrobial effect, the antimicrobial efficacy can be differentiated once again in terms of its strength on the basis of growth curves with MRSA germs. Table 1 shows that both the ruthenium and silver contents (quantities) have an influence on the strength of the efficacy against MRSA. Both metals can be used to control the antimicrobial efficacy of the hybrid material of the invention in terms of the strength required. Table 1 shows the amounts of silver and ruthenium analyzed [wt %] in relation to the entire hybrid material, with the respective antimicrobial strength evaluated as (x+) according to the legend. In principle, it can be stated that ultimately all material variants show a complete antimicrobial effect if sufficient quantities are present. In terms of measurement, therefore, the particle quantity was reduced until a differentiation could be made, because not all variants achieve complete MRSA killing. If a 100 % effect of a silver-ruthenium variant was still detectable with a lower weighting, this was classified as a particularly effective composition. Table 1 thus shows the evaluation for the variants indicated according to the weights.

TABLE 1

| C-720 | Silver (wt. %) | Ruthenium (% by weight) | Antimicrobial efficacy |
|---|---|---|---|
| 1.1 | 18.13 | 1.44 | +++++ |
| 2.2 | 10.93 | 1.01 | ++++ |
| 2.1 | 18.4 | 0.1 | +++ |
| 2.3 | 10.9 | 0.11 | ++ |

+++++ = very strong;
++++ = strong;
+++ = medium;
++ = weak

FIG. 9 a shows an antimicrobial cellulose film produced via the Lyocell process, which has been produced by adding the cellulose-based antimicrobial hybrid material produced according to the invention to the Lyocell process. Similarly, antimicrobial cellulose filaments could also be produced after the Lyocell process. FIG. 9 b shows the antimicrobial efficacy of the cellulose filament produced according to the invention against E. coli (DSM 498) on the basis of the inhibition zone formed around the thin filament. FIG. 9 c shows the significant antimicrobial activity against S. aureus (DSM 799) determined according to DIN EN ISO 20743 by the addition of only 3% of the particulate cellulose-based silver-ruthenium hybrid (720b) to the cellulose spinning solution.

FIG. 10 shows the efficacy of the particulate antimicrobial hybrid material produced according to the invention against SARS-CoV-2 and the Feline Coronavirus (FCoV), which is even more difficult to inhibit. Testing was performed at FU Veterinary Medicine using the so-called plaque assay. Virus plaque assays determine the number of plaque-forming units (pfu) in a virus sample, which is a measure of the amount of virus. This assay is based on a microbiological method performed in Petri dishes or multiwell plates. A viral plaque is formed when a virus infects a cell within the fixed cell monolayer. The virus-infected cell lyses and the infection is transmitted to neighboring cells where the infection-lysis cycle is repeated. The infected cell area forms a plaque (an area of infection surrounded by uninfected cells) that can be visualized with a light microscope or visually. In FIG. 10 a, the plaque reduction assay shows that the cellulose-based antimicrobial particles prepared according to the invention have an antiviral effect against the Feline Coronavirus already at a concentration of about 0.2 mg/ml (IC50: kills 50% of the viruses). In the case of the antiviral effect of the antimicrobial cellulose-based particulate hybrid material according to the invention against SARS-CoV-2 shown in FIG. 10 b, the IC50 is even significantly lower at approx. 0.05 mg/ml. Thus, the antimicrobial hybrid system according to the invention is suitable for combating viruses by integrating the particles into paints, coatings, plastics.

FIG. 11 shows microparticles (antimicrobial powder) prepared on silver particles according to the invention, where commercially available spherical silver powder with a particle size of 1 µm - 100 µm was coated with ruthenium. The silver powder was dispersed in alkaline solution with vigorous stirring. Then solutions of ruthenium(III) chloride and sodium borohydride were added as reducing agents. Dark gray powder with a ruthenium content of 3.2 wt.% was obtained. FIG. 11 a shows the uncoated silver powder and FIG. 11 b the coated antimicrobial powder. FIG. 11 c shows the SEM image of a powder particle at 100,000x magnification with a diameter of about 1 µm. The porous structure of the ruthenium coating is clearly visible. FIG. 11 d shows the inhibition zone test, which demonstrates a high antimicrobial efficiency of the microparticles or powder according to the invention.

FIG. 12 shows the growth curve of MRSA for antimicrobial microparticles based on silver particles according to FIG. 11b. The minimum inhibitory concentration of the particles is 20 mg. A sample without addition of the antimicrobial powder served as a control.

FIG. 13 shows microparticles (antimicrobial powder) according to the invention on a catalytic basis, where the silver powder used as a basis was previously prepared by a chemical-reductive process. Ascorbic acid was used as a reducing agent. In addition, gum arabic was used as an inhibitor. The silver powder prepared was filtered off, washed and coated with ruthenium immediately after filtering. Again, solutions of ruthenium (III) chloride and sodium borohydride were added as reducing agents. FIG. 13 a shows the powder after filtration, washing and drying. Larger, hard, gold-colored particles were formed. These were then ground. FIG. 13 b shows the mortared, black powder. The particle size of the powder varies from 0.1 µm - 5 µm. The ruthenium content is 3.2% by weight. FIG. 13 c shows the SEM image of a powder particle at 100,000x magnification. The diameter is about 0.7 µm.

FIG. 14 shows the growth curve of the microparticles or powder according to FIG. 13. The minimum inhibition concentration of the powder is only 5 mg. This small value is due to the large relative surface area of the small powder particles. A sample without addition of the antimicrobial powder served as a control.

FIG. 15 shows several samples of commercial facade paint to which increasing concentrations of an antimicrobial hybrid material prepared on glass particles according to the invention have been added. The concentration of the powder is 0.1 wt%, 0.5 wt% and 1.0 wt%. The antimicrobial activity of the samples against E. Coli bacteria after the inhibition zone test was determined. All samples showed significant antimicrobial efficiency, which increased with increasing concentration of the powder. The antimicrobial function of the hybrid material is not inhibited by the facade paint. Film preservation of facade paint does not require a pronounced long-distance effect, so much lower concentrations of the hybrid material powder are sufficient for this application. A reference sample with high antimicrobial activity served as a control.

FIG. 16 shows several samples of a commercial antifouling paint to which increasing concentrations of hybrid antimicrobial material powder prepared on cellulose powder have been added. The concentrations of the powder were 2.0 wt%, 4.0 wt% and 8.0 wt%. The antifouling coating without the addition of the antimicrobial powder served as a control. The samples were stored in the North Sea for 6 weeks. After this time, the control sample already showed significant fouling, while the sample with 2.0 wt.% of antimicrobial powder showed fouling only in isolated areas. As the concentration of antimicrobial hybrid material powder increases, the low level of fouling decreases further.

FIG. 17 shows samples of Ultramid C33 containing 1% by weight of antimicrobial microparticles prepared with commercial silver powder. FIG. 17 a shows granules, and FIG. 17 b shows plates. FIG. 17 c shows the inhibition zone test of the samples against E. coli bacteria. Both samples have medium antimicrobial activity. One sample of the plate was incubated for 18 months in deionized water, which was replaced at regular intervals. The antimicrobial activity of the sample is unchanged after incubation because its antimicrobial activity is not due to the leaching of a biocide, but is due to a catalytic process.

FIG. 18 shows polyamide fibers containing 3% by weight of catalytic-based antimicrobial microparticles (FIG. 18 a). The microparticle powder used was produced by reducing silver ions in a chemical-reduction process and subsequent coating with ruthenium. For the powder to be incorporated into the fibers, the size of the particles must be < 5 µm. The fibers have good antimicrobial activity (FIG. 18 b).

FIG. 19 a shows an antimicrobial hybrid material produced according to the invention, the core of which has been made from ferromagnetic iron powder. FIG. 19 b shows how the hybrid particles equipped with a ferromagnetic core can be manipulated completely in the glass container from the outside through a glass wall with a strong permanent magnet. Such a hybrid system can be used, for example, in biological measuring apparatus. FIG. 19 c shows results of the hybrid antimicrobial particle system (arrows) according to the invention for PCR genome analysis on gram-positive B. subtilis germs. The antimicrobial particle system according to the invention had the task of lysing B. subtilis (approx. 1x10exp6 cells) in a 21 µl suspension with PBS for 15 min at RT. Here, the particles could be completely removed from the instrument after the end of the experiment with the aid of a magnet.

FIG. 20 shows an antimicrobial hybrid material coated according to the invention and uniformly distributed in water by vigorous agitation. The particles of the hybrid material in (a) are without post-coating, while the particles of the hybrid material in (b) are subsequently treated in a dopamine hydrochloride solution (2 mg/ml) and a phosphate buffer (0.1 M, pH 8.5) at RT. The dopamine hydrochloride treatment converted the particle surface from the previously hydrophobic state to a hydrophilic one. This resulted in the particles that were hydrophobic without post-coating with dopamine hydrochloride immediately sinking to the bottom of the vessel after agitation, while a stable dispersion can be maintained for a longer time due to the hydrophilized particles (FIG. 20 b).

FIG. 21 shows a cellulose-based antimicrobial hybrid material produced according to the invention, the antimicrobial efficacy of which is not impaired by post-treatment. FIG. 21 a shows the antimicrobial activity of the cellulose-based hybrid particles produced according to the invention without post-treatment against an E. coli (DSM 498) suspension culture (10exp7/ml with 200 µl plated out) on the basis of the pronounced inhibition zone on the agar. In FIG. 21 b, the same size Hemmhof shows that the cellulose-based hybrid particles posttreated with ascorbic acid do not negatively alter the antimicrobial activity of the particles prepared according to the invention. The same applies to the post-treatments with chitosan (FIG. 21 c) and polydopamine (FIG. 21 d).

FIG. 22 shows a cellulose-based antimicrobial hybrid material that has been integrated into sol-gel coating materials (e.g. siloxanes) and provides the sol-gel coating with antimicrobial activity. The two siloxane coatings H 2084 and H 5055 (FIG. 22 a) were used as sol-gel coatings. Hybrid cellulose-based particles were used as antimicrobial additive, which were added to the siloxane coating at a concentration of 5 wt.%. After mixing, the dispersion was applied to the sample support by spraying. The coating was then crosslinked in the drying oven at the appropriate temperature. The powder particles showed good distribution on the sample surface. FIG. 22 b shows antimicrobial test results for E. coli on the agar of polypropylene plates coated on one side with siloxane and coated with 5% by weight of the cellulose-based hybrid antimicrobial material of the invention. The inhibition yard test with E. coli (DSM 498) shows the high antimicrobial activity of the two samples. This was also true for samples that had been subsequently incubated for 5 min in a 1% solution of potassium sulfide. The partially irregular inhibition halo is due to the uneven spray application. It can be seen that the antimicrobial activity of the antimicrobial particles produced according to the invention is hardly affected by the siloxane coating. In this case, the subsequent sulphide post-treatment even leads to an increase in the antimicrobial efficacy of the dispersion coating system. Since siloxane coatings are hard and scratch-resistant in the polymerized state, this antimicrobial dispersion coating system is particularly suitable for surfaces subject to wear and tear.

FIG. 23 shows the growth curves of MRSA bacteria in which the two ruthenium/ruthenium/silver/silver oxide powders have been used with different amounts of powder. Ruthenium can be deposited with different strong reducing agents (e.g., NaBH₄, N₂H₄) by direct, one-step chemical-reduction route, for example, on silver surfaces, and ruthenium/ruthenium oxides can be deposited on the silver surface accordingly. However, ruthenium/ruthenium oxides can also be deposited in a two-step process, in which ruthenium is first oxidized in the first step and the oxidized ruthenium is reduced to ruthenium and ruthenium oxides only in the second step. It was expected that the different process routes for ruthenium/ruthenium oxide deposition on silver particles would lead to comparable antimicrobial efficacy. Surprisingly, however, the two-step process was found to have almost an order of magnitude greater antimicrobial activity of the silver/silver oxide/ruthenium/ruthenium oxide against S. aureus (MRSA) and P. aeruginosa compared to the direct, one-step ruthenium deposition process. Unlike the direct, one-step reduction of Ru (III) ions by a strong reducing agent, the indirect, two-step process relies on the oxidation of Ru (III) ions to ruthenium (VIII) oxide [Chen 2011]. RuO₄ is a strong oxidizing agent that is converted to ruthenium (IV) oxide by suitable reducing agents, coating the carrier material with a layer of ruthenium (IV) oxide. The oxidation of Ru (III) ions to RuO₄ is carried out by sodium hypochlorite. To stabilize RuO₄, the process is carried out in alkaline medium. The reduction to RuO₂ is carried out by sodium nitrite.

### Preparation of Semiconducting Silver / Silver Oxide // Ruthenium / Ruthenium Oxide Powders by Chemical Reductive Deposition of Ru/RuOₓ on Silver Particles Using an Indirect, Two-Step Process for Ruthenium Deposition (AP 383)

50 g silver powder (Toyo Chemical Industrial, SBA10M27) was slurried in a 2000 ml three-neck flask in an ultrasonic bath with 1000 ml deionized water. Additional agitation was performed with the KPG stirrer at 300 rpm. After 2 h, the brown suspension was transferred to another 2000 ml three-neck flask by decantation. In the ultrasonic bath and stirring with the KPG stirrer, 10 ml of Ru(NO)(NO₃)₃ solution (10.83 g/l) was added. Then a mixture of the following solutions was added to the suspension:
300 ml NaClO solution (14 %),
100 ml NaOH solution (10 g/l),
87.5 ml NaNO2 solution (10 g/l).

The silver powder immediately turned dark. The suspension was then stirred for 1 h in an ultrasonic bath. After sedimentation of the coated powder, the yellow supernatant was decanted off. The powder was taken up with deionized water and filtered off. After washing with deionized water, the powder was taken up with ethanol, filtered off and dried in a drying oven at a temperature of 60° C.

### Antimicrobial Effect

Surprisingly, silver / silver oxide // ruthenium / ruthenium oxide powders in which the ruthenium oxide was deposited by the one-step and two-step chemical reduction processes, respectively, show strikingly large differences in antimicrobial testing against MRSA bacteria (Gram-positive). Silver / silver oxide // ruthenium / ruthenium oxide powders (AP823) deposited by direct ruthenium reduction on silver particles with the strong reducing agent sodium borohydride (NaBH4) exhibited antimicrobial activity nearly an order of magnitude lower than silver / silver oxide // ruthenium / ruthenium oxide powders (AP383) deposited by the two-step method. FIG. 23 shows the growth curves of MRSA bacteria in which the two ruthenium / ruthenium oxide // silver / silver oxide powders have been used with different amounts of powder. As can be seen from the shape of the growth curves, the two-step silver / silver oxide // ruthenium / ruthenium oxide powder (AP383) showed complete killing of MRSA bacteria at a weighed powder amount of 2.5 mg, whereas the one-step silver / silver oxide // ruthenium / ruthenium oxide powder (AP823) showed complete killing only at 15 mg powder amount. Thus, the 2-stage ruthenium deposition was found to have significantly increased antimicrobial efficacy compared to the 1-stage method, as indicated by the fact that complete germicide over the entire 8 h experimental period required only 2.5 mg of powder for sample 383(veequivalent Ru deposition method as 392) and > 10 mg for sample 823, i.e., about 4-6 times less. A comparably large difference in antimicrobial activity (approx. one order of magnitude) was found in studies of the antimicrobial activity of both types of powder (AP823) and (AP383) against P. aeruginosa PA 14 (gram-negative).

The antimicrobial effect is particularly high for samples containing ruthenium (VI) oxide in the first half cell (Table 2). Apparently, the ruthenium (VI) oxide can be obtained in both electrochemical and PVD deposition of ruthenium when a process step with strong oxidative effect is present in the ruthenium deposition (392 and RuOx). The XPS surface analyses indicate a correlation between the antimicrobial effect and the composition of the ruthenium oxides, possibly depending on a certain ruthenium (VI) oxide / ruthenium (IV) oxide ratio. In any case, the presence of ruthenium (VI) oxide is beneficial or even necessary for the enhanced antimicrobial activity.

TABLE 2

XPS analysis results - manufacturing process-antimicrobial activity

| Sample designation | Basic material | Ruthenium deposition process | Chemical composition (XPS 3d spectra) * | | | Antimicrobial effect |
|---|---|---|---|---|---|---|
| | | | Ru(0) | RuO2 | RuO3 | |
| 825 | Silver particles | Chemical Reductive Direct Reduction | 280, 1 eV | 280.7 eV | | |
| | | | ++++ | ++++ | n. d. | ++ |
| 392/383 | Silver particles | Chemical-Reductive 2-stage Stage 1: Oxidation Stage 2: Reduction | Very low share | Contained in the broad red peak RuO2 (hydrated). Substantial part is RuO3 | 282.9 eV | |
| | | | + | ++ | +++ | ++++ |
| “Ru” | PE film | PVD sputtering | 280.0 eV | Low proportion in Ru(0) peak | | |
| | | | ++++ | + | n. d. | ++ |
| “RuOx” | PE film | PVD Reactive Sputtering (Oxidative) | | | 282, 1 eV | |
| | | | + | n.d. | ++++ | ++++ |

*) Reference spectrum: silver (The binding energies of the high-resolution spectra were corrected using the Ag3d spectra.

Literature binding energies (eV):
Ru (0): Ru 3d: 280, 2 eV; J. F. Moulder, W. F. Stickle, P. E. Sobol and K. D. Bomben: Handbook of X Ray Photoelectron Spectroscopy: A reference of Standard Spectra for identification and interpretation of XPS Data, J. Chastain and J. R. C. King, Editors, p. 115, Physical Electronics Eden Prairie, Minnesota (1995).

RuO2: Ru 3d: 280, 66 eV; T. P. Luxton, M. J. Eick, K. G. Schekel; Journal of Colloid and Interface Science 359, (2011) 30-39.
RuO3: Ru 3d: 282, 5 eV; T. P. Luxton, M. J. Eick, K. G. Schekel ; Journal of Colloid and Interface Science 359, (2011) 30-39. RuO3: Ru 3d: 282.4 eV; R. Kötz, H. J. Lewerenz and S. Stucki; J. Electrochem. Soc. 130, No. 4, 1983, 825-829.

In addition to the wet chemical 2-step Ru deposition on silver, ruthenium and silver were also deposited by PVD coating on a PE foil, which has the advantage that no silver chloride is present on the PVD samples and any differences that may be detected can be attributed to the ruthenium half cell more unequivocally.

(A) PVD deposition:
(a) Ruthenium sputtering on silver (sample designation “Ru”).
(b) Reactive sputtering (O₂) of silver and ruthenium (sample designation “RuOx”).

(B) Chemical-reductive ruthenium deposition:
(c) direct reduction for ruthenium deposition on silver (sample designation “825”).
(d) Reduction of ruthenium to deposit on silver in the 2-step process already described (oxidation + subsequent reduction, (sample designation “392”).

These 4 samples were analyzed by growth curves and surface composition (XPS analysis). As a result, it has been shown that in both investigations differences occurred within the respective group (A) or (B), but also between groups (A) and (B), with an increased antimicrobial efficiency corresponding to a striking distinction in the surface composition, according to the XPS analysis.

FIG. 24 shows XPS spectra of the samples Ru (a), RuOx (b) as well as 825 (c), 392 (d). Antimicrobial studies had shown, as described above, that there are significant differences in the chemical-reductive deposition and PVD deposition of Ru/RuOx // Ag/AgCI and AgOx-half cell combinations, respectively. The XPS analyses show differences in a striking manner, which correspond to the different antimicrobial efficacies. As can be seen in the Ru3d spectra (FIG. 24), there are the following striking differences both in the group of chemically-reductively prepared samples 825 (c) (curve (1)), 392 (d) (curve (2)) and the group of PVD-coated samples Ru (a) (curve (3)), RuOx (b) (curve (4)) within one group and between the two groups:
A narrow signal from metallic ruthenium (BE = 280.1 eV) is found in sample 825 (a) curve 1. The spectrum of sample Ru consists mostly (65%) of metallic ruthenium and about 24% is assigned to RuO2.
The RuOx (b) sample (curve (4) - PVD oxidation sputtered) contains significantly less Ru(0), making the carbon components more prominent. The largest component (BE = 284.4 eV) would be attributed to metal carbide (C apparently originates from PVD cleaning of the PE film). The ruthenium component of the spectrum is dominated by the signal at BE = 282.1 eV, which accounts for about 85% and can be assigned to RuO3**. The half-width of this component is quite large, so that a contribution of other compounds to the signal cannot be excluded. The remaining Ru components of the spectrum are caused by oxide hydrates of Ru(VI) or higher oxidation states of ruthenium.

Sample 392 (d) curve (2) is similar to sample RuOx (b) curve 4 and also contains RuO3** in significant concentration. In addition, however, other compounds are present which may be oxide hydrates. But Ru compounds with greater valence are also possible. The Ru(0) and RuO2 content is small.

**) According to literature data (Table 1), between 282.2 eV and 282.6 eV RuO₃ is located.

In the oxygen O1s spectra (FIG. 25), one sees a grouping of the samples as described for the Ru3d spectra. The Ru and 825 samples give virtually identical spectra shapes, which can be matched with three components. Metal oxides are expected at BE = 530 eV. The components at larger BE may represent hydroxides and hydrates. However, in all likelihood, significant portions of these are attributable to adsorbates. The RuOx sample is probably significantly influenced by the adsorbates. In addition, the O atoms can be seen in the ruthenium oxides. Sample 392 shows only small proportions of oxidic oxygen atoms. The predominant part is bound in hydrates. In between, hydroxides are probably still to be found.

The XPS analyses show several differences in the oxidic composition of the samples studied. Striking, and possibly a main culprit for the increased antimicrobial efficacy, could be the presence of the hexavalent oxidation state of ruthenium, in addition to the RuO₂ and the metallic Ru(0), in the samples with high antimicrobial efficacy. In particular, in the PVD samples where AgCl is not present, there may be no influence from this side to increase the antimicrobial efficacy.

1. Hybrid material provided as an additive relating to materials, substances and/or coating materials for producing an antimicrobial, antiviral and/or fungicidal effect comprising:
particles, each of which comprising at least one carrier material being at least partially coated with
at least two different metals, wherein
at least one first metal and one second metal of the two different metals are, at least with their respective surfaces, in electrically conductive contact to each other, wherein
the first metal comprises at least one semiconductive compound of at least one transition metal element, which exhibits multiple oxidation states and allows a change of the oxidation states via catalytically active centers, and
the second metal comprises at least one electrically conductive silver semiconductor, wherein
both, the first metal and the second metal, establish half cells which are short-circuited in presence of water and oxygen and thus develop an antimicrobial, antiviral and/or fungicidal effect, and
wherein the carrier material further comprises at least one material adapted to the substance and/or the coating material and a use of the substance and/or the coating material.

2. The hybrid material according to claim 1, wherein the carrier material comprises at least one material selected from the group consisting of cellulose, glass, zeolite, silicate, metal or metal alloy, metal oxide, ceramic, graphite, and a polymer.

3. The hybrid material according to claim 1, wherein the carrier material comprises cellulose.

4. The hybrid material according to claim 1, wherein the hybrid material is modified with organic polymers, and/or with ascorbic acid or derivatives of ascorbic acid.

5. The hybrid material according to claim 1, wherein the first metal and the second metal establish half cells which are short-circuited in presence of water and oxygen and thus develop an antimicrobial effect, wherein the strength of the antimicrobial effect is specifically adjustable through adjusting the amount of at least one of both metals and/or the proportion of both metals on the surface of the particles.

6. The hybrid material according to claim 1, wherein the transition metal element is at least one metal of the group consisting of ruthenium, iridium, vanadium, manganese, nickel, iron, cobalt, cerium, molybdenum, and tungsten.

7. The hybrid material according to claim 1, wherein the transition metal compound of the first metal comprises ruthenium present in one or both of the oxidation states VI and IV.

8. The hybrid material according to claim 1, wherein the transition metal compound of the first metal comprises at least one metal oxide, metal oxyhydrate, metal hydroxide, metal oxyhydroxide, metal halogenide and/or at least one metal sulfide of the transition metal element.

9. The hybrid material according to claim 1, wherein the silver semiconductor comprises at least one silver oxide, silver hydroxide, silver halogenide or silver sulfide, or a combination of silver and a corresponding silver compound.

10. The hybrid material according to claim 1, wherein the particles have a spherical or polyhedric shape and a mean diameter of at most 100 µm including at most 50 µm or at most 5 µm, and/or that the particles have a fiber-like shape and a mean length of at most 1 mm including at most 100 µm at most 75 µm or at most 60 µm.

11. A method for producing a hybrid material having antimicrobial effect including the hybrid material according to-claim 1 comprising
a) providing or producing a particle-shaped carrier material,
b) at least partly applying a first metal onto the carrier material, and
c) at least partly applying a second metal, which differs from the first metal, onto the carrier material and/or onto the first metal, wherein both, the first metal and the second metal, are applied such that they are, at least with their respective surfaces, in electrically conductive contact to each other.

12. The method according to claim 11, wherein at least one of the first metal and second metal is applied onto the carrier material and/or onto the other metal of the first and second metal in cluster-shaped form, nanoporously, microcrackly and/or in form of single particles.

13. The method according to claim 11, wherein after a) and/or c), the carrier material and/or the metals is/are modified with organic polymers including polyethylene glycol, polydopamine and/or chitosan, and/or with ascorbic acid or derivatives of ascorbic acid.

14. The method according to claim 11, wherein a link layer is generated on at least one of the first or second metal, wherein the link layer comprises at least one metal compound of the corresponding first or second metal, which is selected from the group consisting of halogenides, oxides, and sulfides.

15. The method according to claim 11, wherein a strength of an antimicrobial effect of the hybrid material is adjusted by adjusting the an amount of at least one of the first and the second metal and/or the proportion of the first and the second metal on a surface of particles comprising the carrier material being at least partially coated with the first and/or second metal.

16. The method according to claim 11, wherein the the first and second metals are applied sequentially or simultaneously via electrochemical deposition, chemical-reductive deposition, electrophoretic coating, calcinating, PVD, CVD and/or sol-gel processes.

17. The method according to claim 11, wherein application of the second metal onto the carrier material and/or the first metal comprises at least one step having a strong oxidative effect.

18. The method according to claim 11, wherein , after applying the first and second metals, a thermal post-treatment is applied thereby adjusting specific oxidation states.

19. A material, including a coating material, or substance, comprising, as an additive, the hybrid material according to claim 1, wherein the additive confers to the material or substance an antimicrobial, antiviral and/or fungicidal effect.

20. The hybrid material according to claim 4, wherein the organic polymers are polyethylene glycol, polydopamine and/or chitosan.
